(19) United States
(12) Patent Application Publication
(10) Pub. No.: US 2026/0287448 A1
(43) Pub. Date: Sep. 24, 2026

(54) MATRIX ARRAY FORCE SENSOR

(71) Applicant: Peratech IP Ltd, North Yorkshire (GB)

(72) Inventors: Tom MITCHELL-WILLIAMS, North Yorkshire (GB); Daniel WHITING, North Yorkshire (GB); Benjamin BEDDARD, North Yorkshire (GB); Matthew GOSPEL, North Yorkshire (GB)

(73) Assignee: Peratech IP Ltd, North Yorkshire (GB)

(21) Appl. No.: 19/474,182

(22) PCT Filed: Apr. 8, 2024
(86) PCT No.: PCT/GB2024/050930

§ 371 Date: Oct. 9, 2025

(30) Foreign Application Priority Data
Apr. 11, 2023 (GB) 2305295.4

(51) Int. Cl. G01L 1/22; G06F 3/041; G06F 3/045

(52) U.S. Cl. CPC G01L 1/2287; G06F 3/04144; G06F 3/045

(57) ABSTRACT

Examples disclosed relate to a matrix array force sensor having first and second stacked and at least one functional resistive layer located between the first layer and the second layer. The first layer has interdigitated row electrodes. The second layer has interdigitated column electrodes. A location of the force applied to the matrix array force sensor may be determined by the first and second stacked layers and the functional resistive layer.

### TECHNICAL FIELD

The present disclosure relates to a matrix array force sensor, a sensing module including the same, and a method of manufacturing a matrix array force sensor.

### BACKGROUND

Force sensing touchpads may be used in many devices, such as mobile telephones, tablet computers, touch sensitive trackpads and force-sensitive coatings. Users can input single or multi-touch gestures or swipes to interact with the device. Matrix array force sensors need to accurately track the location of a force input (e.g., from a finger or stylus) and measure the force applied. The sensor array needs to have a low latency to respond quickly to the input force.

### BRIEF SUMMARY OF THE DISCLOSURE

Aspects and embodiments of the invention provide a matrix array force sensor, a sensing module including the same, and a method of manufacturing a matrix array force sensor.

In accordance with the present disclosure there is provided a matrix-array force sensor, including: a first layer including: row electrodes each having a longitudinal axis orientated in a first direction, each of the row electrodes including a main body portion and at least one interpolation portion, wherein each interpolation portion includes projections which are interdigitated with the projections of the interpolation portion of an adjacent row electrode to together form a interpolation region, the first layer thereby including at least one row interpolation region; wherein a location of a force applied in a one of the at least one row interpolation regions is determinable in dependence on a first portion of the force detected by the projections of a first of the row electrodes and a second portion of the force detected by the projections of a second of the row electrodes adjacent the first of the row electrodes; a second layer, the first layer and second layer being stacked together, the second layer including: column electrodes each having a longitudinal axis, orientated in a second direction perpendicular to the first direction, each of the column electrodes including a main body portion and at least one interpolation portion, wherein each interpolation portion includes projections which are interdigitated with the projections of the interpolation portion of an adjacent column electrode to together form a interpolation region, the second layer thereby including at least one column interpolation region; wherein a location of the force applied in a one of the column interpolation regions, stacked with the one row interpolation region, is determinable in dependence on a third portion of the force detected by the projections of a first of the column electrodes and a fourth portion of the force detected by the projections of a second of the column electrodes adjacent the first of the column electrodes; at least one functional resistive layer located between the first layer and the second layer; where the location of the force applied to the matrix-array force sensor is determinable in dependence on the detected first, second, third and fourth portions of the force.

The width of the projections may decrease as the projections extend away from the main body portion. The projections may be triangular.

The at least one functional resistive layer may include a first functional resistive layer and a second functional resistive layer, wherein the first layer is adhered to the first functional resistive layer and the second layer is adhered to the second functional resistive layer. The first functional resistive layer and the second functional resistive layer may be patterned layers, wherein a pattern of the first functional resistive layer matches a pattern of the row electrodes and a pattern of the second functional resistive layer matches a pattern of the column electrodes.

The at least one functional resistive layer may include a continuous layer of an anisotropic material, wherein the anisotropic material causes current to flow in predominantly a third direction, orthogonal to the first direction and second direction.

Each one of the projections of the row electrodes and each one of the projections of the column electrodes may include at least one sub-projection, wherein each sub-projection projects away from its corresponding projection.

In an aspect there is provided a sensing module including any matrix-array force sensor disclosed herein and a controller, the controller including at least one processor(s) and memory, the memory including computer program instructions, wherein the computer program instructions, when executed by one or more processor(s), cause the processor(s) to determine the location and strength of a force applied to a touch surface of the sensing module in dependence on the detected first, second, third and fourth portions of the force.

In an aspect there is provided a method of manufacturing a matrix-array force sensor, the method including: forming a first layer, by: forming row electrodes each having a longitudinal axis orientated in a first direction, each of the row electrodes including a main body portion and at least one interpolation portion, wherein each interpolation portion includes projections which are interdigitated with the projections of the interpolation portion of an adjacent row electrode to together form a interpolation region, the first layer thereby including at least one row interpolation region; forming a second layer, by: forming column electrodes each having a longitudinal axis, orientated in a second direction perpendicular to the first direction, each of the column electrodes including a main body portion and at least one interpolation portion, wherein each interpolation portion includes projections which are interdigitated with the projections of the interpolation portion of an adjacent column electrode to together form a interpolation region, the second layer thereby including at least one column interpolation region; forming at least one functional resistive layer; and locating the at least one functional resistive layer between the first layer and the second layer to form a stack.

Forming a one of the at least one functional resistive layer may include forming a continuous layer of an anisotropic material, wherein the anisotropic material causes current to flow in predominantly a third direction, orthogonal to the first direction and second direction. Forming the continuous layer of the anisotropic material may include using conductive particles to bridge an insulating film.

Forming the continuous layer of the anisotropic material may include forming a composite using aligned conductive particles in an insulating matrix. Forming the continuous layer of the anisotropic material may include growing a templating structure including vertical pores and filling the vertical pores with a conductive material. Forming the continuous layer of the anisotropic material may include depositing dots of conductive material within a substrate. Forming a one of the at least one functional resistive layer may include using one of screen printing, flexographic printing and inkjet printing to print the one of the at least one functional resistive layer onto the first layer or the second layer. Forming a one of the at least one functional resistive layer may include depositing a functional resistive layer material through a patterned mask onto the first layer or the second layer. Forming a one of the at least one functional resistive layer may include removing material from a continuous film of a functional resistive layer material.

### BRIEF DESCRIPTION OF THE DRAWINGS

Example embodiments are further described hereinafter with reference to the accompanying drawings, in which:

FIG. 1 shows a schematic example of a portion of adjacent electrodes of a matrix array force sensor according to examples disclosed herein;

FIG. 2 shows an exploded view of layers of an example matrix array force sensor according to examples disclosed herein;

FIG. 3a illustrates an example of tracking a moving applied force on a matrix array force sensor having straight sided electrodes, and FIG. 3b illustrates an example of tracking a moving applied force on a matrix array force sensor having electrodes according to examples disclosed herein;

FIG. 4a is a photograph and a schematic of an example array of matrix array force sensors according to examples disclosed herein and FIG. 4b is a photograph of one of the matrix array force sensors of the array of FIG. 4a;

FIG. 5 illustrates an example sensing module according to examples disclosed herein; and

FIG. 6 illustrates an example method of manufacturing a matrix array force sensor as disclosed herein.

### DETAILED DESCRIPTION

Matrix array force sensors need to accurately track the location of a force input (e.g., from a finger or stylus) and measure the force applied. The sensor array needs to have a low latency to respond quickly to the input force. Matrix array force sensors disclosed herein (which are resistive force sensors) include electrode patterning which can provide improved tracking accuracy with fewer electrode inputs and outputs compared with a traditional matrix array force sensor having straight electrodes having straight sides.

Matrix array force sensors may include a series of electrode strips oriented in a first direction (which may be called row electrodes in a row layer), with an overlying series of electrode strips oriented in a second direction (which may be called column electrodes in a column layer), with a force sensing material between the row and column layers. The electrodes are connected to electrical tracks to allow for electrical input and output to and from the electrodes. Application of a force to the surface of the matrix array force sensor may be detected by the decrease in separation distance between one of more electrodes of the row electrode layer and one or more electrodes of the column electrode layer changing the electrical resistance at the point of force application. This change in resistance can be detected and converted into a measure of the force applied and the location of the force on the matrix array force sensor.

To improve location tracking accuracy of a force applied to a matrix array force sensor, the pitch of rows of electrodes, and the pitch of columns of electrodes, as well as the pitch of force sensing resistive (FSR) material can be reduced. Pitch may be defined as the distance separating neighbouring electrodes in an electrode layer (or the distance between neighbouring like features in a particular layer). However, reducing the pitch leads to technical challenges. Forming finer (smaller) features, for example by deposition, requires tighter manufacturing tolerances and can result in lower production yields as it is more difficult to manufacture without errors affecting performance of the matrix array force sensor. Also, the reduced pitch increases the number of inputs and outputs required to and from the electrodes of the sensor array, which increases complexity of the control electronics and increases latency, making the sensor slower to respond.

Another approach to this problem of improving force sensing accuracy is to maintain a large pitch between electrodes (and therefore retain a low number of inputs and outputs) but to improve the virtual resolution of the sensor array by changing the pattern of the force resistive layer. For example, the resistive layer may be formed (e.g. deposited) as a blanket print covering all column and row electrodes, as a resistive layer having relatively wide rows and wide columns with relatively small gaps between adjacent rows and adjacent columns, or as a layer having interdigitated fingers of material between adjacent electrodes. These approaches rely on an in-plane, sheet resistance, contribution to the sensor resistance which is proportional to the position of the press relative to the sense electrodes. This line-resistance component means that the total sensor signal no longer corresponds directly to the force of the input alone and instead has a complex interdependence of force and position, affecting total sensor response. This increases the complexity of deconvolving the press location and total force of the press. An issue for the blanket print approach is the lateral signal spreading that can occur in-plane, making it difficult to track position accurately near the edge of a sensor array. The interdigitated finger design requires high resolution patterning of the functional resistive layer, which adds production complexity and increases the chance of parts landing out-of-specification. In this disclosure, the terms “functional resistive layer”, “resistive layer”, and “force resistive layer” may be used interchangeably.

Examples disclosed herein include first and second electrode layers and at least one functional resistive layer located therebetween. The electrode layers each include a plurality of strip electrodes, and in plan view of the matrix array force sensor, the direction of the strip electrodes in the first electrode layer is different to the direction of the strip electrodes in the second electrode layer. In each electrode layer, the plurality of electrodes include a main body portion and at least one interpolation portion. The interpolation portion of an electrode includes a plurality of projections from a long edge of the electrode, which are interdigitated with the plurality of projections of the interpolation portion of an adjacent electrode. Together the interdigitated interpolation portions of the adjacent electrodes form an interpolation region. A force applied to the matrix array force sensor in the interpolation region includes force components detected by each electrode having an interpolation portion in the interpolation region where the force is applied. Thus in the example of having two electrode layers with the electrode orientation in one electrode layer being non-parallel with the electrode orientation in the other electrode layer and a functional resistive layer therebetween, force components of two adjacent electrode interpolation portions in the first layer and force components of two adjacent electrode interpolation portions in the second layer may be detected and used to determine the location of the applied force to the matrix array force sensor.

Advantages of such examples as disclosed herein over previous matrix array force sensors include a high accuracy tracking, due to the use of the interpolation regions, with fewer inputs and outputs than, for example, simply reducing electrode pitch, because the electrodes have a main body with interpolation portions (as opposed to using more, smaller, electrodes overall to achieve finer resolution), whilst still being able to straightforwardly determine the total applied force of a press input as a result of the straightforward combination of detected force components from electrode interpolation regions interacted with by an applied force.

By having an effective pattern for the functional resistive layer or layers of the resistive matrix array force sensor (for example by the pattern of a functional resistive layer matching the pattern of the corresponding adjacent electrode projections), the matrix array force sensor allows for interpolation of a force applied in the interpolation region to more accurately detect the position of the applied force.

The force sensor may generally be composed of two opposing substrates each with patterned electrodes as described below. At least one substrate has a functional resistive layer coating, attached to, or overlaying, the electrodes (for example, the functional resistive layer may include a quantum tunnelling material. A quantum tunnelling material is a material which exhibits a change in electrical resistance in response to a change in force or pressure applied. Quantum tunnelling materials of this type are available from the present applicant, Peratech Holdco Limited, Brompton-on-Swale, United Kingdom under the registered trade mark QTC®.). The electrodes may be arranged in rows and columns on each substrate such that when assembled, the electrodes and associated functional resistive layers form a sensor with the intersections of row electrodes from one substrate with columns on the other forming a regular array. This type of structure then has NxM sensing areas (“sensels”) from a total of N+M inputs and outputs.

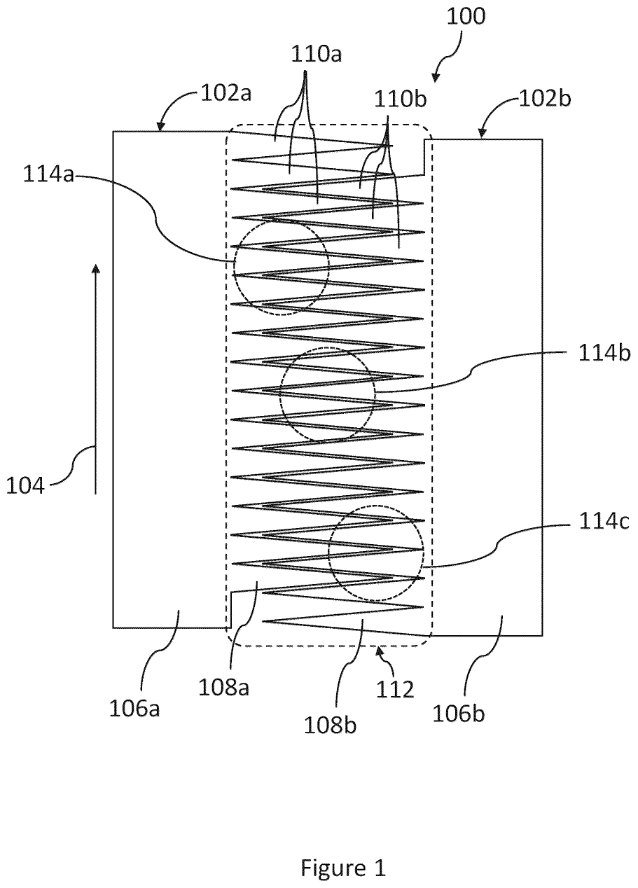

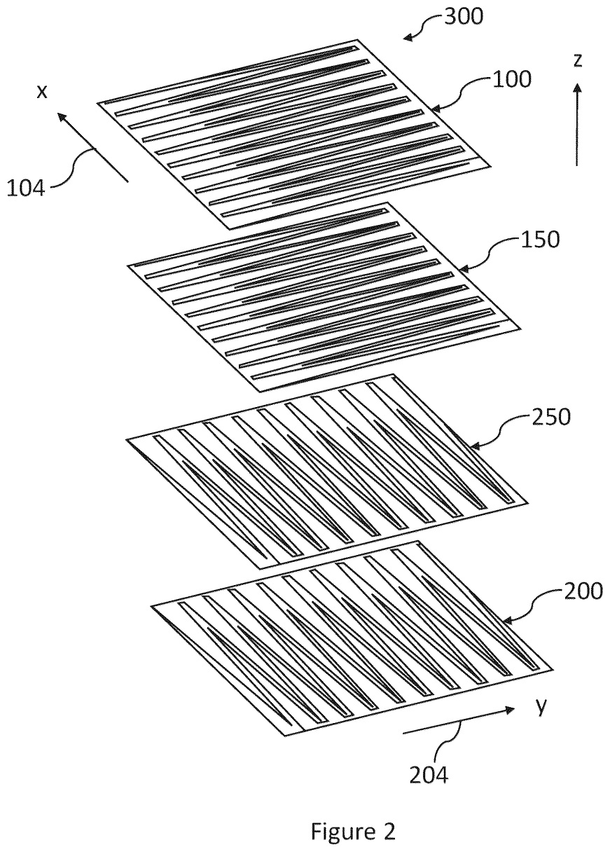

To increase the tracking the resolution without increasing the number of inputs and outputs (i.e. the number of row/column intersections) examples disclosed herein use a pattern of projections between the rows and columns of the matrix array sensor so that a force signal location can be interpolated. This means the press location between rows/columns can be calculated without requiring additional inputs and outputs to those used to connect to each row or column. The interpolation is achieved by patterning the electrodes such that there is a continuous change in area fraction occupied by each adjacent electrode in the region between rows or columns (i.e. a gradual tapering of electrode material between adjacent electrodes). One such example pattern is shown schematically in FIG. 1.

FIG. 1 illustrates a schematic example of a portion 100 of adjacent electrodes 102a, 102b of a matrix array force sensor. The electrodes 102a, 102b may form part of a layer, or electrode layer, in a matrix array force sensor. The electrodes 102a, 102b each have a longitudinal axis 104 which is orientated in a first direction (vertically as shown). Each of the electrodes 102a, 102b includes a main body portion 106a, 106b and at least one interpolation portion 108a, 108b. Each interpolation portion 108a, 108b includes a plurality of projections 110a, 110b which are interdigitated with the plurality of projections 110a, 110b of the interpolation portion 108a, 108b of an adjacent row electrode 102a, 102b to together form a interpolation region 112.

Each electrode 102a, 102b as illustrated includes one interpolation portion 108a, 108b along one long edge of its main body 106a, 106b. It may be envisaged that an electrode 102a, 102b may include two interpolation portions 108a, 108b, located at opposite long edges of the main body 106a, 106b. While two electrodes 102a, 102b are shown, it may be envisaged that more than two electrodes may be present. Thus it may be envisaged that an electrode layer may include one or more electrodes including one interpolation portion along a long edge of the electrode main body, and one or more electrodes including two interpolation portions along opposite long edges of the electrode main body. For example the electrode layer may include two outer electrodes each oriented with their longitudinal axes parallel, each of the two outer electrodes including a respective interpolation portion in which the projections are directed from the outer electrode main body towards the centre of the electrode layer, and one or more inner electrodes each including two respective interpolation portions along opposing long sides of the inner electrode main body, each inner electrode main body also parallel with the main body of each outer electrode. The interpolation portions of the outer and inner electrodes may be interdigitated to provide the electrode layer in which a series of electrodes with parallel main body portions lie in a plane with interdigitated interpolation portions between adjacent electrodes in the plane.

As illustrated in FIG. 1, the location of an applied force 114a, 114b, 114c in the interpolation region 112 will be detected to a different extent by each electrode 102a, 102b, because the proportion of the force applied to the two interpolation portions 108a, 108b of the respective electrodes 102a, 102b differs according to where, along a path perpendicularly between the electrodes 102a, 102b, the force is applied. In this example, the projections 110a, 110b from an electrode 102a, 102b main body 106a, 106b taper to a smaller size as the distance away from the main body 106a, 106b increases. The projections 110a, 110b in this example may be described as triangular or zig-zag in shape, and have a continuously varying (decreasing) size as the distance from the electrode main body decreases. Thus the matrix-array force sensor may include projections as above, wherein the width of the projections decrease as the projections extend away from the main body portion; the projections may be triangular.

Another way of describing the projections 110a, 110b in the interpolation region 108a, 108b of the portion 100 of adjacent electrodes 102a, 102b of the matrix array force sensor of FIG. 1 is that the projections 110a, 110b are arranged such that the area fraction of each row electrode 102a, 102b present in the interpolation region 112 (the area fraction being viewed from a direction normal to the sensor surface), varies continuously across the interpolation region (e.g. in a direction from the first electrode 102a main body 106a to the second electrode 102b main body 106b). The area fraction may be thought of as, for an area in the interpolation region, how much of that area is occupied by projections of one of the electrodes, compared with how much of that area is occupied by projections of the other of the electrodes.

As shown in FIG. 1, due to the tapering shape of the projections 110a, 110b, a force 114a applied closer to the first electrode 102a main body 106a than the second electrode 102b main body 106b (i.e. towards a first side of the interpolation region 112) includes a higher area fraction relating to the first electrode 106a than the second electrode 106b. A force 114b applied at a distance equally far from the first electrode 102a main body 106a and the second electrode 102b main body 106b (i.e. in the central portion of the interpolation region 112) includes the same area fraction relating to the first electrode 106a and the second electrode 106b. A force 114c applied closer to the second electrode 102b main body 106b than the first electrode 102a main body 106a (i.e. towards a second side of the interpolation region 112) includes a higher area fraction relating to the second electrode 106b than the first electrode 106a.

A force 114a located in the interpolation region 112 closer to the first electrode 102a main body 106a than the second electrode 102b main body 106b interacts with an area of electrode material which is composed of more electrode material of the first electrode 102a than electrode material of the second electrode 102b. A force 114b located in the interpolation region 112 the same distance away from the first electrode 102a main body 106a as from the second electrode 102b main body 106b interacts with an area of electrode material which is the same area of electrode material of both the first electrode 102a and the second electrode 102b. A force 114c located in the interpolation region 112 closer to the second electrode 102b main body 106b than the first electrode 102a main body 106a interacts with an area of electrode material which is composed of more electrode material of the second electrode 102b than electrode material of the first electrode 102a.

Thus, the location of a force 114a, 114b, 114c applied in the interpolation region 112 is determinable in dependence on a first portion of the force 114a, 114b, 114c detected by the projections 108a of the first electrode 102a and a second portion of the force 114a, 114b, 114c detected by the projections 108b of the second electrode 102b adjacent to the first electrode 102a.

It will be appreciated that there are other shapes of projection 110a, 110b which may be used which also provide the functionality of allowing for the position of a force applied between in the interpolation region to be determined due to a variation in the shape of the projections 110a, 110b. For example, the projections 110a, 110b may have at least partially curved sides. As another example, the projections 110a, 110b may taper to a point at the projection ends (opposite to the part of the projection 110a, 110b connected to the main body 106a, 106b, but may have parallel sides between the tapering portion and the main body 106a, 106b. In some examples, each one of the plurality of projections 110a, 110b of the plurality of row electrodes and/or each one of the plurality of projections of the plurality of column electrodes may include at least one sub-projection, wherein each sub-projection projects away from its corresponding projection; the projections may therefore have a dendritic shape in some examples. Other projection shapes may be envisaged.

A projection shape as illustrated in FIG. 1 may be advantageous because, for a first and second adjacent electrode with respective linearly tapering interdigitated interpolation portions as shown, the proportion of the applied force detected as applied to a first electrode decreases linearly and the proportion of the applied force detected as applied to a second electrode increases linearly as the location of the force moves perpendicularly to the first and second electrodes in a direction from the first to the second electrode.

The arrangement of electrodes 102a, 102b having longitudinal axes running in a first direction 104 allows for the location of a force applied to the interpolation region 112 to be detected as a position between the first electrode 102a and the second electrode 102b. That is, the position of an applied force in the two dimensional plane of the electrode layer surface may be determined in one dimension. In order to determine the position of an applied force in the two dimensional plane of the electrode layer surface in two dimensions, a second layer may be arranged on top of (i.e. superimposed on) a first layer to form a sandwich structure with the functional resistive material layer between the two electrode layers, wherein the longitudinal direction of the electrodes in the two layers is different. For ease of calculation of the force position, the longitudinal direction of the electrodes in the two layers may be orthogonal (i.e. the electrodes in the first electrode layer are oriented at 90 degrees to the electrodes in the second electrode layer). In this way, the location of the force may be detected in a first direction from one electrode layer, and in a second direction from the other electrode layer, allowing for the force position to be determined in two dimensions.

Moving from a position (e.g. force location 114a) close to electrode 102a (i.e. the main body 106a of electrode 102a) toward electrode 102b (i.e. the main body 106b of electrode 102b), in the interpolation region 112, the relative area fraction of the electrodes 102a, 102b varies continuously as the location moves from occupying a greater proportion of projections 110a of the first electrode 102a, to occupying a greater proportion of projections 110b of the second electrode 102b.

Preferably, the pattern of projections 110a, 110b should be reproduced with sufficient resolution to ensure that force spread from a press input 114a, 114b, 114c covers an area corresponding to several electrode pattern features (projections). The signal measured by each electrode 102a, 102b, will be proportional to the relative area occupied by each electrode in the press location 114a, 114b, 114c. Therefore, the relative signal on each electrode 102a, 102b can be used to interpolate the press location 114a, 114b, 114c when it is located between rows/columns (see FIG. 2).

FIG. 2 shows an exploded view of layers of an example matrix array force sensor having a first electrode layer 100 (which may be called a row electrode layer), a first functional resistive layer 150 associated with the first electrode layer 100, a second electrode layer 200, and a second functional resistive layer 250 associated with the second electrode layer 200. The longitudinal direction 104 of the electrode main bodies of the first electrode layer 100 is orthogonal to the longitudinal direction 204 of the electrode main bodies of the second electrode layer 200. In this example, there are two electrodes illustrated in each electrode layer 100, 200, but in other examples there may be more than two electrodes as discussed above.

The arrangement of FIG. 2 alongside FIG. 1 may be considered to illustrate a matrix-array force sensor 300, including: a first layer 100 including: a plurality of row electrodes each having a longitudinal axis orientated in a first direction 104, each of the plurality of row electrodes including a main body portion and at least one interpolation portion, wherein each interpolation portion includes a plurality of projections which are interdigitated with the plurality of projections of the interpolation portion of an adjacent row electrode to together form a interpolation region, the first layer thereby including at least one row interpolation region; wherein a location of a force applied in a one of the at least one row interpolation regions is determinable in dependence on a first portion of the force detected by the projections of a first of the plurality of row electrodes and a second portion of the force detected by the projections of a second of the plurality of row electrodes adjacent the first of the plurality of row electrodes; a second layer 200, the first layer 100 and second layer 200 being stacked together, the second layer 200 including: a plurality of column electrodes each having a longitudinal axis orientated in a second direction 204 perpendicular to the first direction 104, each of the plurality of column electrodes including a main body portion and at least one interpolation portion, wherein each interpolation portion includes a plurality of projections which are interdigitated with the plurality of projections of the interpolation portion of an adjacent column electrode to together form a interpolation region, the second layer thereby including at least one column interpolation region; wherein a location of the force applied in a one of the column interpolation regions, stacked with the one row interpolation region, is determinable in dependence on a third portion of the force detected by the projections of a first of the plurality of column electrodes and a fourth portion of the force detected by the projections of a second of the plurality of column electrodes adjacent the first of the plurality of column electrodes; at least one functional resistive layer 150, 250 located between the first layer 100 and the second layer 200; where the location of the force applied to the matrix-array force sensor 300 is determinable in dependence on the detected first, second, third and fourth portions of the force.

The matrix-array force sensor in FIG. 2 is an example in which the at least one functional resistive layer includes a first functional resistive layer 150 and a second functional resistive layer 250. The first layer 100 may be adhered to the first functional resistive layer 150. The second layer 200 may be adhered to the second functional resistive layer 250.

It can also be seen in this example that the first functional resistive layer 150 and the second functional resistive layer 250 are patterned layers. The first functional resistive layer 150 is patterned to match the row electrode pattern of the first electrode layer 100, and similarly, the second functional resistive layer 250 is patterned to match the column electrode pattern of the second electrode layer 200. The resistive layer(s) are therefore patterned to match the electrode they are deposited on to/associated with. If only one of the electrode layers has an associated resistive layer but the other of the electrode layers does not have an associated resistive layer, then the resistive layer has a pattern matching the electrode layer it is associated with.

One or more of the functional resistive layers 150, 250 may include a continuous layer of an anisotropic material; the anisotropic material is configured to cause current to flow in predominantly a third direction (indicated as z in FIG. 2) which is orthogonal to the first direction (shown as x) and the second direction (shown as y).

The conductive electrodes 102a, 102b prevent significant line resistance, which helps ensure that the total signal between upper and lower substrates 100, 150; 200, 250 remains simply proportional to the total applied force, without dependence on position. The conductive material could be a metal. For example, silver, copper, aluminium or gold. Other suitable materials include conductive polymers or composites such as conductive carbon inks. A preferred characteristics of the material conductivity of the electrodes is that the contribution from line resistance is substantially less than (<10%) the value of the contact resistance in the assembled force sensor 300. The patterning of the electrodes in the interpolation region 112 may be achieved, for example, using selective deposition such as masked vapour deposition, lithography, printing or deposition onto a pre-patterned substrate. The patterning may also be achieved subtractively by selectively removing material from a continuous layer using, for example, laser ablation, etching or mechanical removal of material.

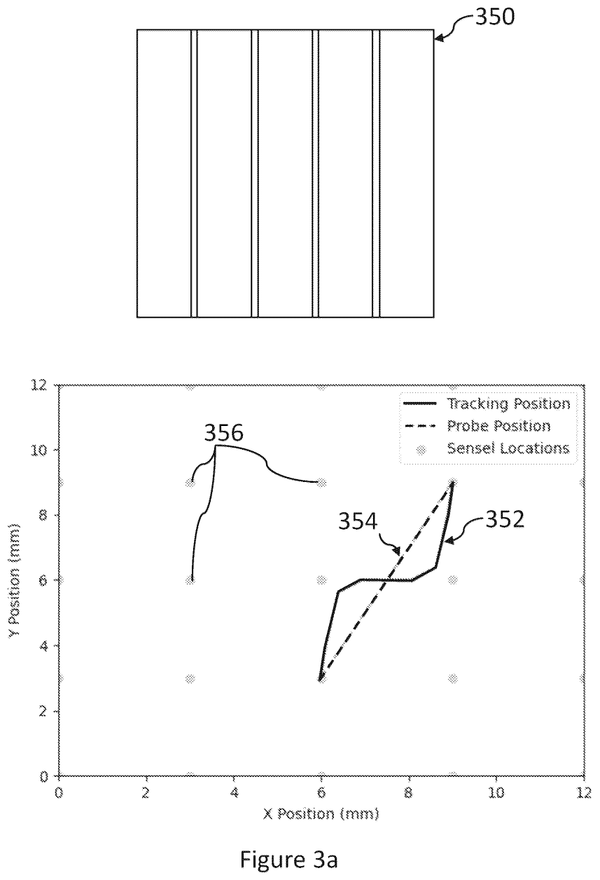

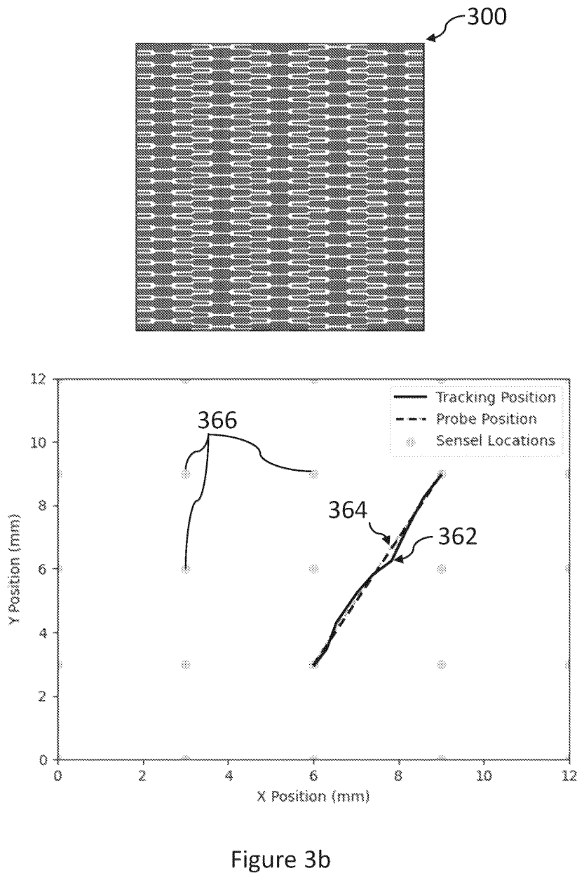

FIG. 3a illustrates a simulation providing an example of tracking a moving applied force on a matrix array force sensor 350 having straight sided electrodes. FIG. 3b illustrates an example of tracking a moving applied force on a matrix array force sensor 300 having electrodes as discussed above in relation to FIGS. 1 and 2. The sensor dimensions are shown as 12 mm×12 mm and each sensel 356, 366 defines the corner of a 3 mm×3 mm grid (i.e. each position in which a row electrode (main body of a row electrode in the example of FIG. 3b) crosses the column electrode (main body of a column electrode in the example of FIG. 3b) every 3 mm). It can be seen that there is a greater error (approximately 0.9 mm) in detected tracking position 352 compared with the actual change in location of the applied force 354 in the example in FIG. 3a, than the error (approximately 0.2 mm) in detected tracking position 362 compared with the actual change in location of the applied force 364 in the example in FIG. 3b. Thus, simulation of the position tracking performance of sensors as discussed herein from FIG. 3b indicates that the maximum predicted positional error is substantially lower than the equivalent pitch straight-edged standard matrix array design as in FIG. 3a.

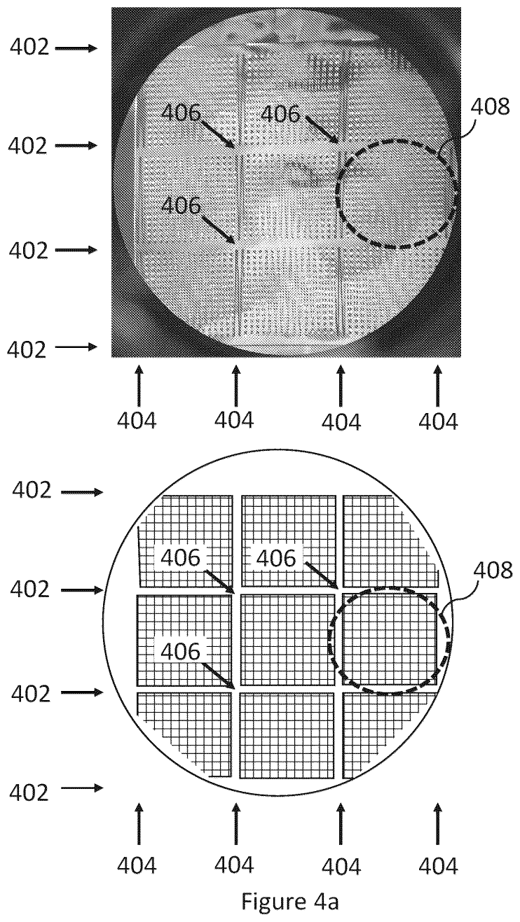

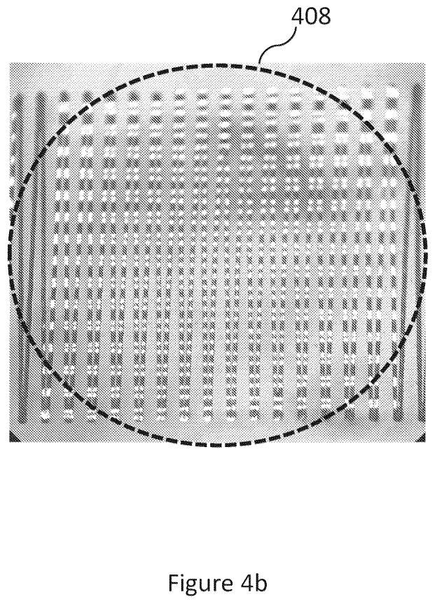

FIG. 4a is a photograph and a schematic of an example array of matrix array force sensors according to examples disclosed herein alongside a schematic representation of the photograph, and FIG. 4b is a photograph of one of the matrix array force sensors of the array of FIG. 4a. The image shows row electrodes 402, column electrode positions 404, sensel positions 406, and an interpolation region 408 is indicated.

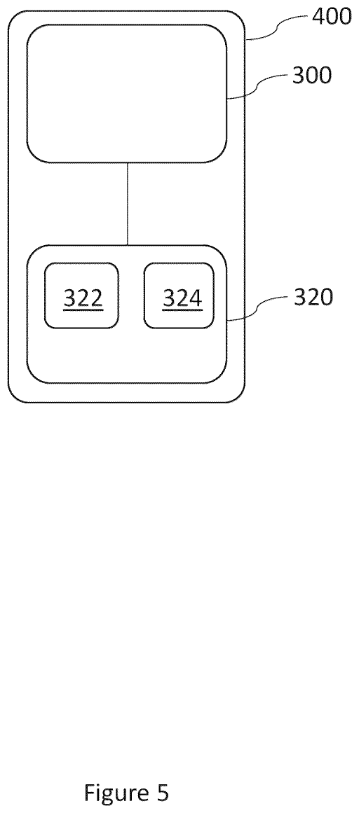

FIG. 5 illustrates an example sensing module 400. The sensing module 400 includes a matrix-array force sensor 300 as discussed above, and a controller 320. The controller 320 includes at least one processor 322 and memory 324. The memory 324 includes computer program instructions which, when executed by one or more processor 322, cause the processor 322 to determine the location and strength of a force applied to a touch surface of the sensing module 400 (i.e. to the matrix array force sensor 300 of the sensing module 400) in dependence on the detected first, second, third and fourth portions of the force.

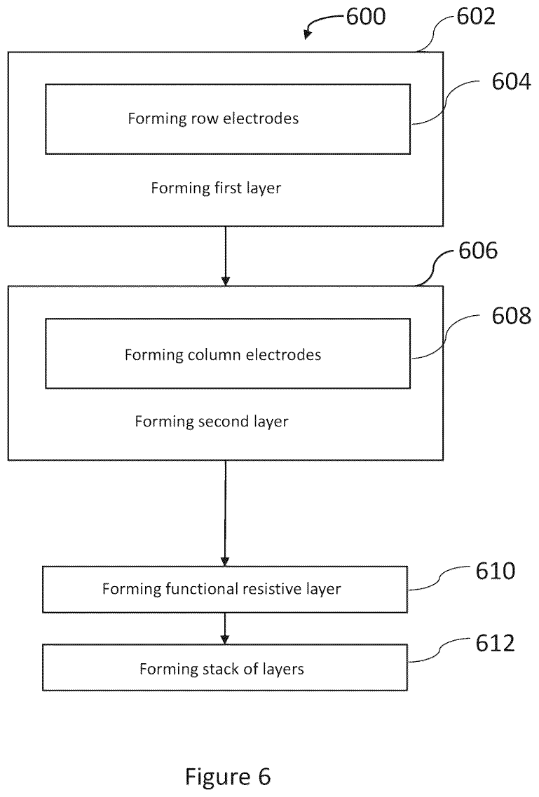

FIG. 6 illustrates an example method 600 of manufacturing a matrix array force sensor. The method 600 includes forming a first layer 602, by forming a plurality of row electrodes 604 each having a longitudinal axis orientated in a first direction, each of the plurality of row electrodes including a main body portion and at least one interpolation portion, wherein each interpolation portion includes a plurality of projections which are interdigitated with the plurality of projections of the interpolation portion of an adjacent row electrode to together form a interpolation region, the first layer thereby including at least one row interpolation region. The method 600 includes forming a second layer 606, by forming a plurality of column electrodes 608 each having a longitudinal axis, orientated in a second direction perpendicular to the first direction, each of the plurality of column electrodes including a main body portion and at least one interpolation portion, wherein each interpolation portion includes a plurality of projections which are interdigitated with the plurality of projections of the interpolation portion of an adjacent column electrode to together form a interpolation region, the second layer thereby including at least one column interpolation region. The method includes forming at least one functional resistive layer 610, and locating the at least one functional resistive layer between the first layer and the second layer 612 to form a stack. It will be appreciated that forming the first layer 602, forming the second layer 606, and forming the at least one functional resistive layer 610, may be done in any order and/or simultaneously, then the resulting components are stacked together 612.

Forming a functional resistive layer 610 may include forming a continuous layer of an anisotropic material. The anisotropic material is configured to cause current to flow in predominantly a third direction, orthogonal to the first direction and second direction, as shown in FIG. 2. Forming the continuous layer of the anisotropic material may include using conductive particles to bridge an insulating film such as in anisotropic conducting film (ACF). Forming the continuous layer of the anisotropic material may include forming a composite using aligned conductive particles in an insulating matrix. Forming the continuous layer of the anisotropic material may include growing a templating structure including vertical pores (i.e. a porous columnar structure such as that forming during aluminium anodizing) and filling the vertical pores with a conductive material such as a resistive ink. Forming the continuous layer of the anisotropic material may include depositing dots of conductive material within a substrate which may also provide preferable anisotropy requirements by preventing lateral current flow within the anisotropic layer. Other examples of forming an anisotropic material layer may be envisaged.

An anisotropic material may be deposited as a continuous layer over the electrodes. This removes the need for complex, high-resolution patterning. This material may be deposited as a pre-existing film or deposited as a precursor ink (e.g. via printing) before curing in-situ or grown directly on the surface of the electrode. The high anisotropy of the layer forces current to flow predominantly in the z-direction. This anisotropy helps ensure any lateral current spreading (in the plane of the sensor) is minimised and means that the relative area fractions of the row/column electrodes result in a signal measured between the electrodes that is inversely proportional to the distance from the specific electrode. For example, in FIG. 1, the relative area occupied by the first electrode 102a at press location 114a is higher than that occupied by the second electrode 102b and so the signal measured by the first electrode 102a will be higher than the signal measured by the second electrode 102b in a ratio that is proportional to the relative area fraction of the two electrodes at that location.

The anisotropic layer may preferably have a resistivity in the xy-plane of >40× the resistivity in the z-axis (perpendicular to the plane of the electrodes). The absolute resistivity of the anisotropic material may preferably be such that the contact resistance between the contacting interfaces during a press is >10× the largest line resistance of the electrode material. This relative resistivity helps ensure that the contact resistance at the contact interface dominates the sensor response and means the total signal magnitude can be used to interpret the force applied to the sensor.

Forming a functional resistive layer 610 may include using screen printing, flexographic printing or inkjet printing to print the functional resistive layer onto the first layer and/or the second layer. Forming the functional resistive layer 610 may include depositing a functional resistive layer material through a patterned mask onto the first layer and/or the second layer. Forming the functional resistive layer 610 may include removing material from a continuous film of a functional resistive layer material. Other methods of forming the functional resistive layer 610 may be envisaged. One technical challenge with depositing a patterned resistive layer is matching the electrode pattern precisely, which requires good registration. To negate this challenge the patterning of the resistive layer may be done simultaneously with the electrode patterning (e.g. during laser ablation patterning) or using the same template. For example, if the electrode is deposited using a lithographic process then the resistive layer can also be deposited before the photopolymer mask is removed. Another technique is to utilize a prepatterned, embossed, substrate to achieve patterning in both the electrode and resistive layer.

Functionality of the functional resistive layer in addition to being “resistive” preferably include that: the bulk resistivity of the material is within specific limits to achieve the force dependent change in contact resistance suitable for the application of the sensor; the surface roughness or surface texture should be well controlled and suitable for the application of the sensor; the material should be stable to temperature fluctuations that are relevant for the application of the final sensor (for example, <5% change in the bulk resistivity when tested at 85 C vs 20 C); the material should be mechanically robust enough the accommodate durability testing with a cyclic load (for example, 5 million cycles with <10% relative change in measured properties); and the material should be mechanically robust/compliant enough to accommodate any bending or stretching stresses that might occur during assembly, integration or during use of the sensor.

Advantages of the sensors discussed herein include the use of fewer inputs and outputs required for a fixed matrix tracking resolution compared with a sensor using simple straight-sided strip electrodes as in FIG. 3a. Examples disclosed herein enable the production of larger area matrix arrays without compromising on tracking precision or requiring more expensive control electronics which is desirable in the manufacture of larger screen devices such as laptops and monitors. Conversely, the complexity of the ancillary electronics required for smaller matrix sensors may also be reduced, therefore, reducing total solution costs, which is desirable in the manufacture of force sensitive devices such as trackpads, touch sensitive buttons and handheld controllers and devices.

Throughout the description and claims of this specification, the words “comprise”, “include”, and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

It will be appreciated that various changes and modifications can be made to the present invention without departing from the scope of the present application.

1. A matrix-array force sensor, comprising:
a first layer comprising:
a plurality of row electrodes each having a longitudinal axis orientated in a first direction, each of the plurality of row electrodes comprising a main body portion and at least one interpolation portion, wherein each interpolation portion comprises a plurality of projections which are interdigitated with the plurality of projections of the interpolation portion of an adjacent row electrode to together form a interpolation region, the first layer thereby comprising a row interpolation region;
wherein a location of a force applied in the row interpolation region is determinable in dependence on a first portion of the force detected by the projections of a first of the plurality of row electrodes and a second portion of the force detected by the projections of a second of the plurality of row electrodes adjacent the first of the plurality of row electrodes;
a second layer, the first layer and second layer being stacked together, the second layer comprising:
a plurality of column electrodes each having a longitudinal axis, orientated in a second direction perpendicular to the first direction, each of the plurality of column electrodes comprising a main body portion and at least one interpolation portion, wherein each interpolation portion comprises a plurality of projections which are interdigitated with the plurality of projections of the interpolation portion of an adjacent column electrode to together form a interpolation region, the second layer thereby comprising column interpolation region;
wherein a location of the force applied in the column interpolation region, stacked with the row interpolation region, is determinable in dependence on a third portion of the force detected by the projections of a first of the plurality of column electrodes and a fourth portion of the force detected by the projections of a second of the plurality of column electrodes adjacent the first of the plurality of column electrodes;
at least one functional resistive layer located between the first layer and the second layer;
where the location of the force applied to the matrix-array force sensor is determinable in dependence on the detected first, second, third and fourth portions of the force.

2. The matrix-array force sensor as claimed in claim 1, wherein a width of the projections decrease as the projections extend away from the main body portion.

3. The matrix-array force sensor as claimed in claim 1, wherein the projections are triangular.

4. The matrix-array force sensor as claimed in claim 1, wherein the at least one functional resistive layer comprises a first functional resistive layer and a second functional resistive layer, wherein the first layer is adhered to the first functional resistive layer and the second layer is adhered to the second functional resistive layer.

5. The matrix-array force sensor as claimed in claim 4, wherein the first functional resistive layer and the second functional resistive layer are patterned layers, wherein a pattern of the first functional resistive layer matches a pattern of the plurality of row electrodes and a pattern of the second functional resistive layer matches a pattern of the plurality of column electrodes.

6. The matrix-array force sensor as claimed in claim 1, wherein the at least one functional resistive layer comprises a continuous layer of an anisotropic material, wherein the anisotropic material causes current to flow in predominantly a third direction, orthogonal to the first direction and second direction.

7. The A matrix-array force sensor as claimed in claim 1, wherein each one of the plurality of projections of the plurality of row electrodes and each one of the plurality of projections of the plurality of column electrodes comprise at least one sub-projection, wherein each sub-projection projects away from its corresponding projection.

8. A sensing module comprising the matrix-array force sensor of claim 1 and a controller, the controller comprising at least one processor(s) and memory, the memory comprising computer program instructions, wherein the computer program instructions, when executed by one or more processor(s), cause the processor(s) to determine the location and strength of a force applied to a touch surface of the sensing module in dependence on the detected first, second, third and fourth portions of the force.

9. A method of manufacturing a matrix-array force sensor, the method comprising:
forming a first layer, by:
forming a plurality of row electrodes each having a longitudinal axis orientated in a first direction, each of the plurality of row electrodes comprising a main body portion and at least one interpolation portion, wherein each interpolation portion comprises a plurality of projections which are interdigitated with the plurality of projections of the interpolation portion of an adjacent row electrode to together form a interpolation region, the first layer thereby comprising at least one row interpolation region;
forming a second layer, by:
forming a plurality of column electrodes each having a longitudinal axis, orientated in a second direction perpendicular to the first direction, each of the plurality of column electrodes comprising a main body portion and at least one interpolation portion, wherein each interpolation portion comprises a plurality of projections which are interdigitated with the plurality of projections of the interpolation portion of an adjacent column electrode to together form a interpolation region, the second layer thereby comprising at least one column interpolation region; and
forming at least one functional resistive layer;
locating the at least one functional resistive layer between the first layer and the second layer to form a stack.

10. The method as claimed in claim 9, wherein forming a one of the at least one functional resistive layer comprises forming a continuous layer of an anisotropic material, wherein the anisotropic material causes current to flow in predominantly a third direction, orthogonal to the first direction and second direction.

11. The method as claimed in claim 10, wherein forming the continuous layer of the anisotropic material comprises using conductive particles to bridge an insulating film.

12. The method as claimed in claim 10, wherein forming the continuous layer of the anisotropic material comprises forming a composite using aligned conductive particles in an insulating matrix.

13. The method as claimed in claim 10, wherein forming the continuous layer of the anisotropic material comprises growing a templating structure comprising vertical pores and filling the vertical pores with a conductive material.

14. The method as claimed in claim 10, wherein forming the continuous layer of the anisotropic material comprises depositing dots of conductive material within a substrate.

15. The method as claimed in claim 9, wherein forming a one of the at least one functional resistive layer comprises using one of screen printing, flexographic printing and inkjet printing to print the one of the at least one functional resistive layer onto the first layer or the second layer.

16. The method as claimed in claim 9, wherein forming a one of the at least one functional resistive layer comprises depositing a functional resistive layer material through a patterned mask onto the first layer or the second layer.

17. The method as claimed in claim 9, wherein forming a one of the at least one functional resistive layer comprises removing material from a continuous film of a functional resistive layer material.
